(19) United States
(12) Patent Application Publication
(10) Pub. No.: US 2021/0016452 A1
(43) Pub. Date: Jan. 21, 2021

(54) AUXETIC-STRUCTURES-BASED SOFT GRIPPERS FOR GRIPPING SURFACES WITH MULTIPLE CURVATURES

(71) Applicant: UNIVERSITY OF GUELPH, Guelph (CA)

(72) Inventors: Hari SIMHA, Mississauga (CA); Mohammad BIGLARBEGIAN, Guelph (CA); Elliott DARCEL, York (CA); Benjamin DAVEY, Mitchell (CA); Brett SICARD, Kitchener (CA); Spencer WEAVER, Owen Sound (CA)

(21) Appl. No.: 16/889,199

(22) Filed: Jun. 1, 2020

Related U.S. Application Data
(60) Provisional application No. 62/855,637, filed on May 31, 2019.

(51) Int. Cl. B25J 15/00; B25J 15/12; B29C 64/106; B25J 9/14

(52) U.S. Cl. CPC B25J 15/0023; B25J 15/12; B33Y 80/00; B25J 9/142; B29C 64/106

(57) ABSTRACT

A soft gripper comprising at least one actuator, the at least one actuator comprising: a top layer and a bottom layer; wherein the top layer comprises at least one fluid chamber comprising a plurality of compartments separated from each other and interconnected to induce flexion upon introduction of a fluid into the at least one fluid chamber; and wherein the bottom layer comprises an auxetic structure adaptable to conform to an object being grasped.

### FIELD

The present invention relates to soft robotics, more particularly it relates to end effectors comprising soft polymer materials.

### BACKGROUND

Soft robotics is a field of robotics that uses soft polymer materials rather than conventional hard materials for end effector construction. Soft materials are useful in robotics for gripping objects that may be damaged, especially in instances where the exact size and shape of the item being grasped are not known. In these cases, soft materials can conform to the item being grasped rather than damaging it. One problem that still exists in the current implementations of soft robotics is that the soft robotic grippers are designed to grasp objects by pinching the object with the tips of the fingers. In doing so, the tips of the fingers apply pressure points to the object being grasped, thereby making the object susceptible to damage. Another problem with soft robotic grippers is they often have weak gripping power and poor actuation.

### SUMMARY

In one of aspect of the invention, there is provided a soft gripper comprising at least one actuator, the at least one actuator comprising:

a top layer and a bottom layer;

wherein the top layer comprises at least one fluid chamber a plurality of compartments separated from each other and interconnected to induce flexion upon introduction of a fluid into the at least one fluid chamber; and

wherein the bottom layer comprises an auxetic structure adaptable to conform to an object being grasped.

In another of aspect of the invention, there is provided a method of manufacture for an actuator, the method comprising the steps of:
using an extrusion process to create an auxetic structure;
molding a fluid chamber comprising a fluid channel with a plurality of compartments separated from each other and interconnected to each other by the air channel;
integrating the fluid chamber with the auxetic structure.

In another of aspect of the invention, there is provided a method of manufacture for an actuator comprising the step of:
3D printing the actuator, wherein the actuator comprises:
   a top layer and a bottom layer;
   wherein the top layer comprises at least one fluid chamber comprising a plurality of compartments and interconnected to induce flexion upon introduction of a fluid into the at least one fluid chamber; and
   wherein the bottom layer comprises an auxetic structure adaptable to conform to an object being grasped.

In another of aspect of the invention, there is provide an actuator comprising:
a top layer and a bottom layer; wherein the top layer comprises at least one fluid chamber having an air column with a series of sections separated from each other and interconnected to induce flexion upon introduction of a fluid into the at least one fluid chamber; and wherein the bottom layer comprises an auxetic structure adaptable to conform to an object being grasped.

In another of aspect of the invention, there is provided an actuator comprising an auxetic metamaterial mesh having a negative Poisson's ratio, and capable of conforming to multiply curved surfaces, while providing a soft cushioning buffer for gripping an object, and providing improved actuation, without sacrificing gripping strength.

Advantageously, an end effector comprising auxetic materials of the present invention is capable of easily conforming to an object being gripped or manipulated owing to the negative Poisson's ratio, which leads to a synclastic curvature of the gripping surface. The auxetic fingers of the end effector actuate when a pneumatic force is connected and the auxetic fingers curl up much like a human finger. This actuating property combined with an auxetic structure designed on the inside of the finger distinctly sets it apart from any robotic gripper on the market.

In addition, the auxetic material is substantially compliant, and the honeycomb style design of the auxetic material of the present invention allows the material to expand in areas that force is not applied to, such that the material is capable of conforming to the curvature of an object and evenly apply distributed pressure to the object. Accordingly, the auxetic finger applies even pressure over the entire target object rather than concentrating pressure on small surface areas.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 shows an auxetic soft gripper system, in one exemplary embodiment;

FIG. 2 shows a re-entrant honeycomb geometry of an auxetic metamaterial;

FIG. 3 shows an ANSYS simulation of an auxetic mesh structure;

FIG. 4 shows a 2D auxetic mesh structure;

FIG. 5 shows a 3D auxetic mesh structure;

FIG. 6 shows a 3D auxetic mesh structure, in another exemplary embodiment;

FIG. 7 shows an auxetic soft gripper finger;

FIG. 8 shows a cross-sectional view of the auxetic soft gripper finger taken along A-A′ in FIG. 7;

FIG. 9a shows an isometric view of the auxetic soft gripper finger;

FIG. 9b shows a top view of the auxetic soft gripper finger;

FIG. 9c shows a side view of the auxetic soft gripper finger;

FIG. 9d shows a front view of the auxetic soft gripper finger;

FIG. 9e shows an exploded view of a cell of the auxetic mesh structure integrated with the auxetic soft gripper finger;

FIG. 10 shows a block diagram of the auxetic soft gripper system;

FIG. 11 shows a schematic of an electrically controlled pneumatic system; and

FIG. 12 shows a table with results from air chamber trials.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Like reference numerals are used to designate like parts in the accompanying drawings.

The detailed description provided below in connection with the appended drawings is intended as a description of the present examples and is not intended to represent the only forms in which the present example may be constructed or used. However, the same or equivalent functions and sequences may be accomplished by different examples.

FIG. 1 shows a gripping assembly, generally identified by reference numeral 10, in an exemplary embodiment. Gripping assembly 10 comprises soft gripper 12 having a plurality of soft gripper fingers or actuators 14 adaptable to manipulate object 16. To actuate soft gripper fingers 14, an electrically controlled pneumatic system 18 comprising a programmable controller provides constant air pressure on demand to any one of soft gripper fingers 14, via electrically operated valves, is used, as will be described later.

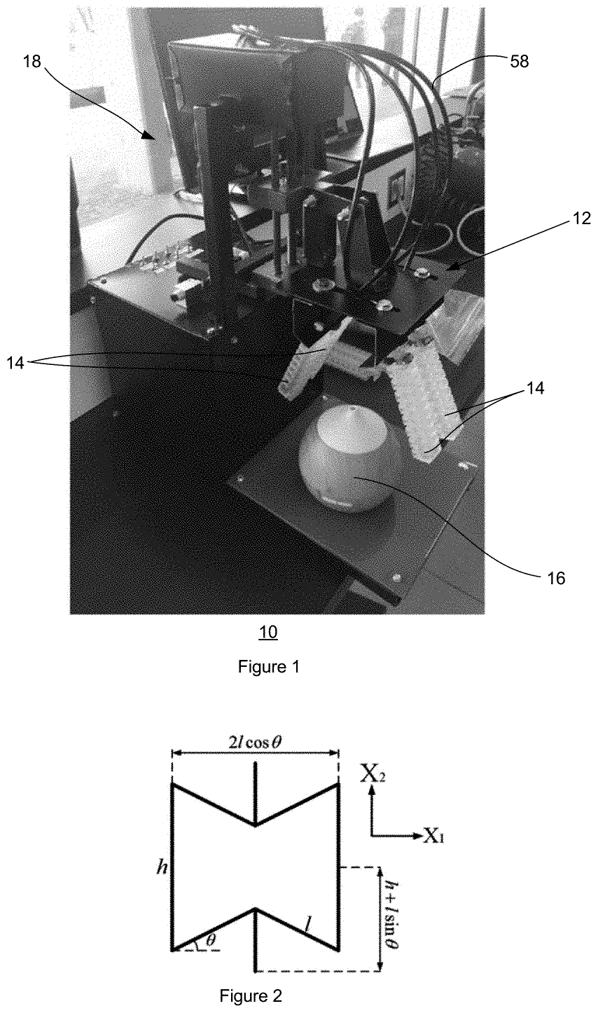

The present inventors have conducted studies to evaluate the properties of various metamaterials, and specifically, auxetic materials, as they relate to soft grippers as disclosed herein. To achieve a soft gripper that was capable of conforming to delicate or objects with multiply curved surfaces, an auxetic metamaterial was integrated on a pneumatic finger. The first phase of the design process was to analyze various auxetic geometries and the unique deformation profile produced after a load or pressure was applied. This unique deformation would allow fingers 14 incorporating the auxetic mesh to more readily conform to asymmetrical objects or objects with multiply curved surfaces than a conventional soft gripper. By simulating the deformation of the various geometries in ANSYS® finite element software, from ANSYS, Inc., Canonsburg, Pa., U.S.A., re-entrant honeycomb auxetic structure 20, as illustrated in FIG. 2, was selected as the preferred auxetic geometry. Since auxetic property is a structure or geometry dependent phenomenon, design iterations were conducted on this geometry and various parameters were adjusted to assess the change in performance. In one example, auxetic unit cell 20 comprised a geometry featuring a re-entrant angle (Θ) value of 45°, a height (h) value of 14.0 mm, and a 2l cos(Θ) of 8 mm, with a thickness (l) set to 1 mm for the auxetic section. These design constraints resulted in auxetic structure 20 that was strong enough to withstand shear forces that would otherwise tear auxetic structure 20, or easily collapse on itself when subjected to a pressure loading.

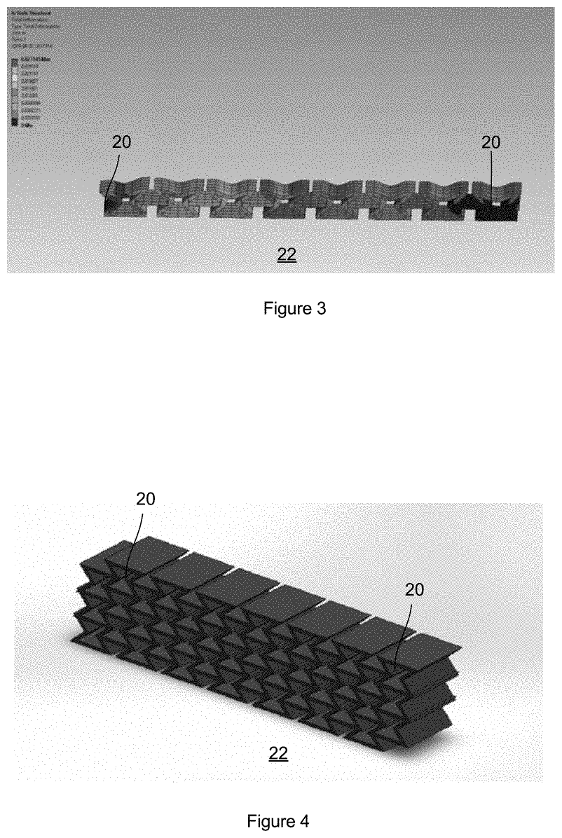

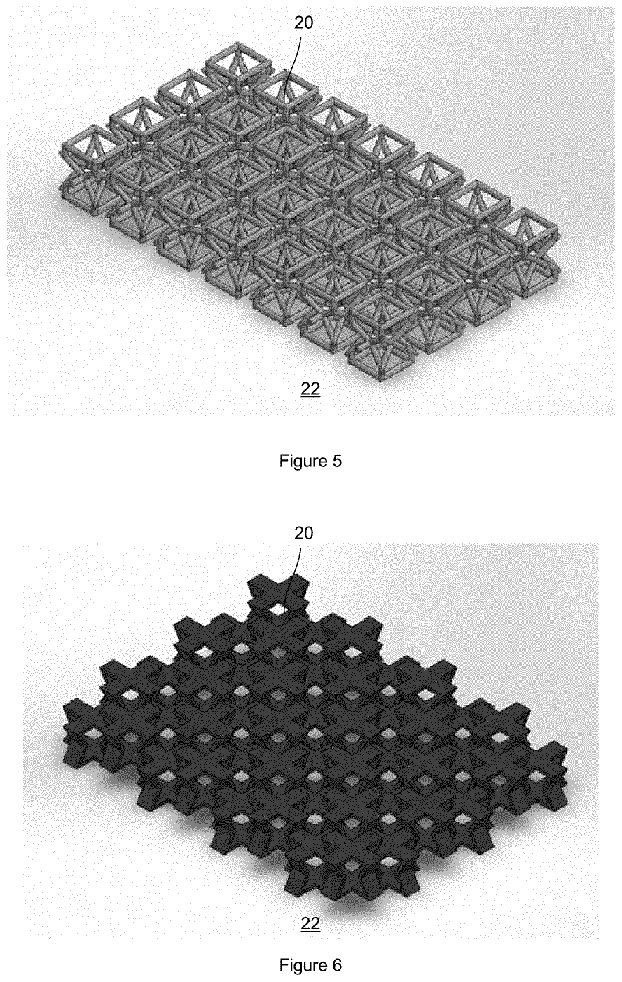

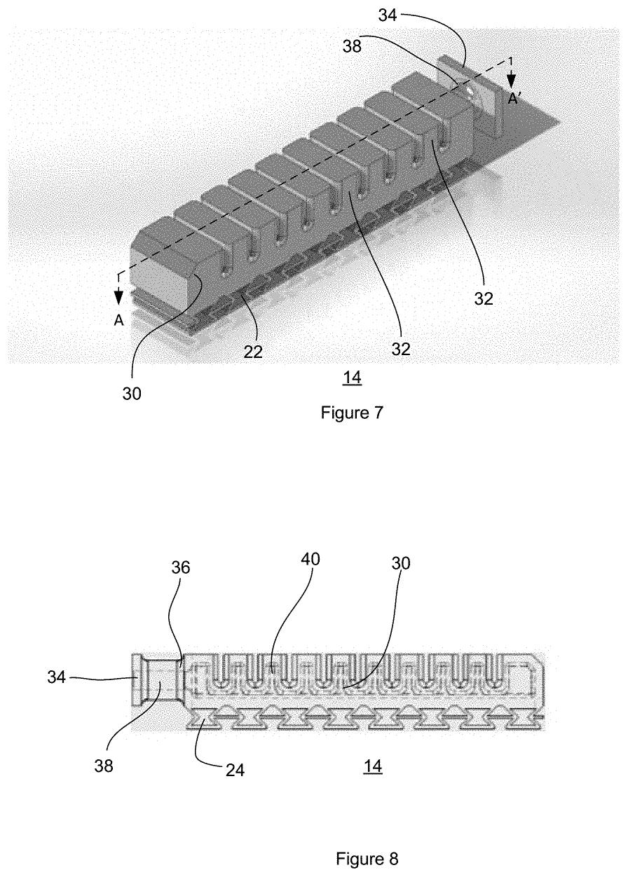

A sequence of these auxetic unit cells 20 formed auxetic metamaterial mesh structure 22, and the sequence was further studied on ANSYS. As can be seen in FIG. 3, in the simulation, a pressure loading was applied on top of auxetic metamaterial mesh structure 22, and this loading caused each auxetic unit cell 20 to collapse inwards and therefore produced metamaterial behavior, without rupturing. A variety of auxetic mesh structures 22 were manufactured in 2D and in 3D, as shown in FIGS. 4, 5 and 6. In an exemplary implementation, a 2D auxetic mesh structure, such as the one shown in FIG. 4, which exhibits auxetic behaviour in two dimensions was selected for the construction of auxetic metamaterials-based finger 14. Next, the design of finger 14 for soft gripper 12 was undertaken, such that auxetic metamaterial mesh structure 22 could be integrated with finger 14 to effect a soft gripping mechanism. As shown in FIG. 7, the design of finger 14 comprises fluid chamber 30 split into a plurality of compartments, such as, vertical columns 32, such that when pressurized fluid, such as air, is introduced into fluid chamber 30 via inlet port 34 extending from collar 36 and through neck 38, columns 32 are engorged with air and thus create a deformation profile that was well suited for gripping. In order to design a suitable fluid chamber 30 for finger 14 various parameters were altered on ANSYS, such as size, thickness of the fluid chamber 30, size of inlet port 34 and the number of vertical columns 32.

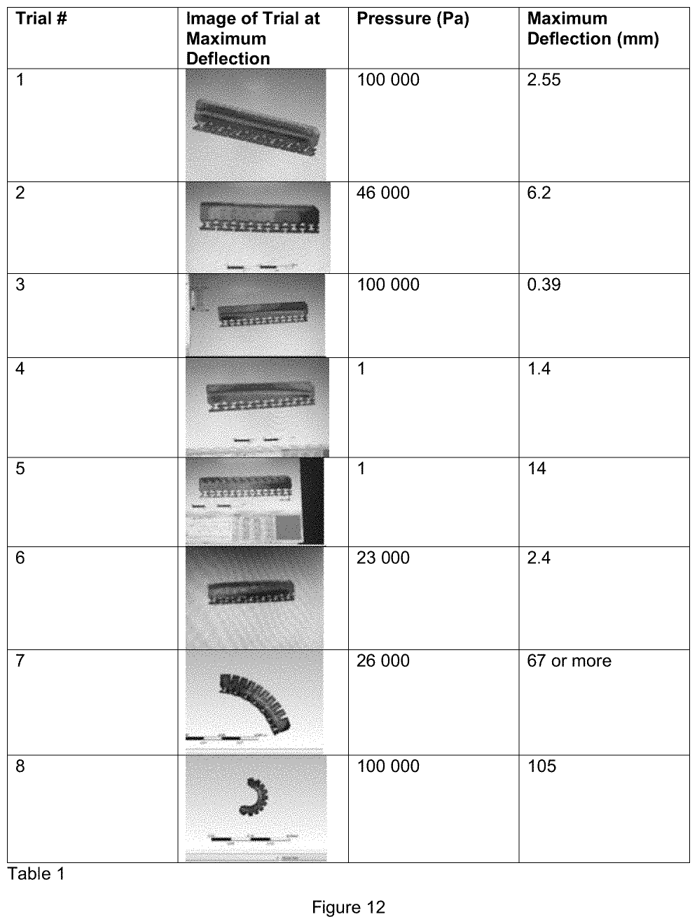

The results of the air chamber trials measuring the maximum deflection of the auxetic soft gripper were analyzed to assess the merits and limitations of each design alteration. Each ANSYS trial can be seen in Table 1 of FIG. 12.

Following the simulations, soft pneumatic finger 14 was manufactured using a Form 2™ printer from Formlabs Inc., from Somerville, Mass., U.S.A., numerous adjustments were made to overcome certain manufacturing issues, such as cracking between the vertical columns 32 which was overcome by adding fillets or chamfers to the region where the cracking occurred. As can be seen in FIG. 8, the thickness of wall 40 of fluid chamber 30 was changed from 2 mm in the first design to 3.50 mm. The fillet sizes were also adjusted during the iterations of the design and the final dimension was 1.75 mm, and finger 14 did not exhibit any failure along the fillet at that dimension. Also, another attempt was made to fillet fluid chamber 30 internally in order to relieve some stress on finger 14. These refinements were helpful in decreasing the stress concentration in between the vertical air columns 32.

Another issue that was observed was cracking along collar 36 of finger 14 when air was applied over time. Accordingly, the thickness of neck 38 was adjusted to be 3.75 mm in the final run, which greatly increased durability. Also, inlet port 34 was adjusted to fit onto a ¼-inch barb fitting coupled to tubing supplying the air to finger 14.

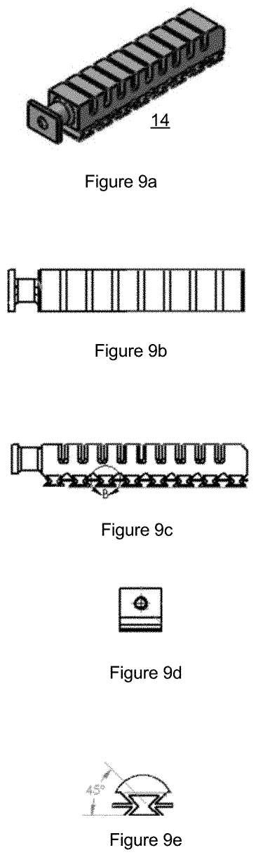

Next, auxetic layer 22 comprising the re-entrant honeycomb auxetic geometry was extruded in a two-dimensional profile, based on plates and shells, and added to the bottom of soft pneumatic finger 14. FIG. 9 shows various views of auxetic finger 14, in one exemplary implementation. This integration of metamaterials increased the diversity of soft gripper 12 as it was able to successfully pick up delicate and/or fragile objects, as well as asymmetric objects. Auxetic layer 22 also allowed soft gripper 12 to have a substantial range of deformation and decreased the impact felt on objects 16 when soft gripper 12 was applied. As shown in FIG. 1, the final design featured four auxetic soft grippers 14 that were placed in pairs. The final assembly 10 comprised a system that could move vertically to allow for fingers 14 to reach and pick up various objects, such as a delicate wine glass.

Now looking again at FIG. 1, in operation soft robotic auxetic gripper 12 actuates when a pneumatic force is connected and auxetic fingers 14 curl up much like a human finger. This actuating property, combined with an auxetic structure 22, designed on the inside of fingers 14, allows for fingers 14 to conform to any object 16 or surface allowing it to be picked up. As such, soft robotic auxetic gripper 12 allows for substantial flexibility and tolerance by being adaptable to conform to, and handle, different sized objects 16, and objects with varying degrees of delicacy. This flexibility and tolerance are largely due to the structural properties of auxetic layer 22, and by varying the grasping force exerted by fingers 14 on objects 16. The grasping force is controllable by adjusting the pneumatic pressure inserted into fingers 14, such that no matter how far fingers 14 flex or bend, each finger 14 has a constant controlled pressure therein. Accordingly, whether object 16 is small or large, fingers 14 will conform to object 16 with the same relative pressure. Therefore, there is no input required to pick up objects 16 of the same weight and different sizes.

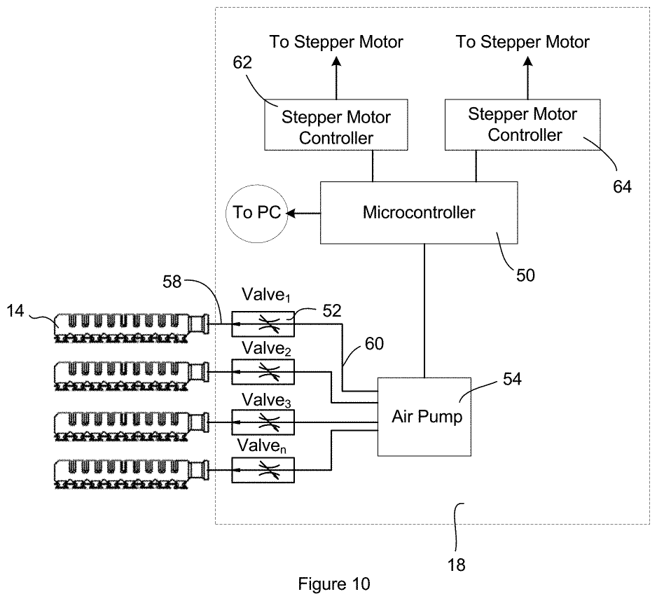

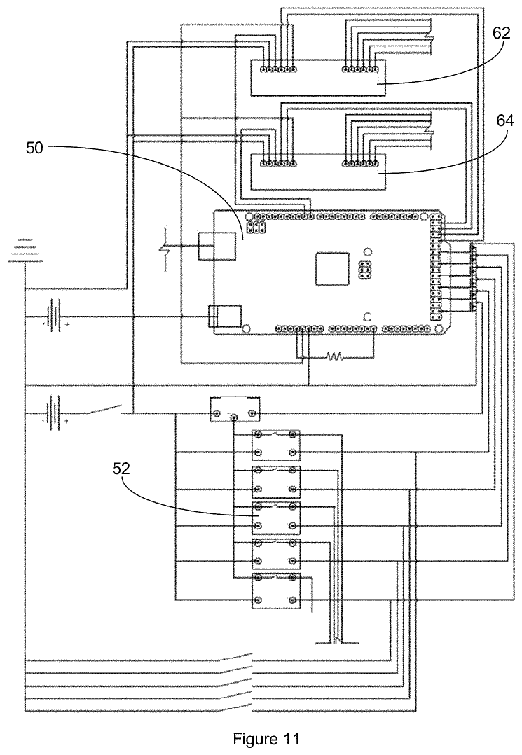

FIG. 10 shows a block diagram of soft gripper system 10 for handling objects 16, while FIG. 11 shows a schematic of electrically controlled pneumatic system 18 for actuating soft gripper fingers 14. Microcontroller 50 controls pneumatic system 18 comprising electrically-controlled valves 52 operable to provide constant air pressure on demand to each finger 14 using regulated air supply 54. In one exemplary implementation, an Arduino™ board with microcontroller 50 is employed, and MOSFET transistors are used to switch valves 52 between open and closed positions. Microcontroller 50 may be coupled to a computing system to receive program instructions to manipulate soft gripper 12.

The MOSFET switches are connected to interrupt pins on the Arduino board, triggering interrupt service routines to open and close valves 52 to inflate and deflate fingers 14. Each finger 14 is connected to valve 52 via tubing 58 introduced into inlet port 34 of finger 14, and valve 52 is coupled to regulated air supply 54 via tubing 60. For inflation, the valve to the main air line of system 18 is opened to allow system 18 to be pressurized by regulated air supply 54. An air manifold splits the main air pressure into each finger 14 when the switch to inflate is enabled. Valves 52 for the fingers 14 are opened and the blow off valve is closed, causing fingers 14 to be pressurized and inflate to grasp object 16. To deflate finger 14, the valve to the main air line is closed, thereby blocking pressure from regulated air supply 54. The blow off valve and all the finger valves 52 are opened to allow pressure to be drained from system 18, thereby deflating fingers 14 and releasing object 16 being grasped.

In addition, assembly 10 allows for an up and down motion, which allows soft gripper 12 to reach object 16. Accordingly, in one exemplary implementation, switches are set up to control the vertical motion, for example, one switch is coupled to a stepper motor via stepper motor controller 62 to control the downward motion, another switch is coupled to another stepper motor via stepper motor controller 64 to control the upward motion, and yet another switch is employed to stop the motion in either direction. In one exemplary implementation, the air pressure in fingers 14 required to pick up various light objects is in the range of 20-25 psi depending on weight.

In another exemplary implementation, pneumatic system 18 is associated with pressure sensors which provide readings to microcontroller 50 for regulating air pressure within system 18. For example, each finger 14 or each valve 52, may be associated with a pressure sensor which output readings to microcontroller 50 for regulating air pressure to finger 14.

In another exemplary implementation, soft robotic gripper 12 comprising auxetic metamaterials 22 may be used to grasp complex objects 16, or handle fragile objects 16, all with an enhanced degree of certainty. For example, one implementation may be in the food industry where it could be used to pick up delicate food items such as eggs and tomatoes, which would result in decreased damage to the food items, and increased revenue, than conventional soft grippers. Soft robotic auxetic gripper 12 may also be useful in the shipping, manufacturing, and distribution industries.

In another exemplary implementation, the auxetic structure 22 is manufactured via a 3D printing process. The ability to 3D print materials with softer, more elastic materials properties thus allows for rapid development of soft robots, and may include a mix of materials of different properties to provide, for example, variable stiffness, flexibility, friction, or elasticity.

In yet another exemplary implementation, the auxetic structure 22 is manufactured via a plastic extrusion process, and the fluid chamber 30 is molded separately. Accordingly, the auxetic structure may be produced on a larger scale, thereby making it more cost effective and quality consistent. The fluid chamber 30 may thus be manufactured out of a more durable material that is better suited for inflation and bending.

In yet another exemplary implementation, fluid chamber 30 receives one of a gas, a gas mixture, a liquid or a liquid mixture.

In yet another exemplary implementation, fingers 14 uses servos, non-contact, contact, or a combination of sensors for feedback. The sensor may be used for detecting many variables such as: position, force, torque, velocity, and acceleration, and may include hall sensors, accelerometers, ultrasonic, or photoelectric sensors, among others.

In another exemplary implementation, additives are applied to the silicone in the manufacturing process, before or after 3D printing, to make fingers 14 more durable and lengthen the life expectancy of finger 14. The suitable additive minimizes cracks and irregularities associated with 3D printing the fingers. Accordingly, additives are included with the liquid silicone before printing such that the additives strengthen the structure of the silicone after printing, while still remaining flexible enough to actuate pneumatically. Alternatively, the additive is applied to the exterior and interior of the silicone finger after the curing process to strengthen and fuse any 3D print anomalies and cracks.

In another exemplary implementation, by having a soft robotic auxetic gripper 12 made solely of silicone with no sharp edges the possibility of injury to an operator by soft gripper 12 is substantially minimized, thereby increasing safety. Additionally, the paucity of rigid materials on soft gripper means impact with an operator is less likely to result in injury.

In another exemplary implementation, soft robotic auxetic gripper 12 made from silicone makes it ideal for use in the agriculture and food distribution industries, since silicone is a sanitary and food grade handling material.

In another exemplary implementation, a soft robotic auxetic gripper 12 is integrally formed using any suitable manufacturing method.

In another exemplary implementation, a soft robotic auxetic gripper 12 is integrally formed using a 3D printing process, based on plates and shells.

In another exemplary implementation, microcontroller 50 is a computing means including a computing system comprising at least one processor, at least one memory, input/output (I/O) module and communication interface. The memory is capable of storing instructions and data, and the processor is capable of executing instructions. The processor may be configured to execute hard-coded instructions, or the processor may be embodied as an executor of software instructions, wherein the software instructions may specifically configure the processor to perform algorithms and/or operations described herein when the software instructions are executed.

The processor may be embodied as a multi-core processor, a single core processor, or a combination of one or more multi-core processors and one or more single core processors. For example, the processor may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, Application-Specific Standard Products (ASSPs), System-on-a-chip systems (SOCs), Complex Programmable Logic Devices (CPLDs), Graphics Processing Units (GPUs), and the like. For example, some or all of the device functionality or method sequences may be performed by one or more hardware logic components.

The memory may be embodied as one or more volatile memory devices, one or more non-volatile memory devices, and/or a combination of one or more volatile memory devices and non-volatile memory devices. For example, the memory may be embodied as magnetic storage devices (such as hard disk drives, floppy disks, magnetic tapes, etc.), optical magnetic storage devices (e.g., magneto-optical disks), CD-ROM (compact disc read only memory), CD-R (compact disc recordable), CD-R/W (compact disc rewritable), DVD (Digital Versatile Disc), BD (BLU-RAY™ Disc), and semiconductor memories (such as mask ROM, PROM (programmable ROM), EPROM (erasable PROM), flash ROM, RAM (random access memory), etc.).

The I/O module may include, but are not limited to, an input interface and/or an output interface. Some examples of the input interface may include, but are not limited to, a keyboard, a mouse, a joystick, a keypad, a touch screen, soft keys, a microphone, and the like. Some examples of the output interface may include, but are not limited to, a microphone, a speaker, a ringer, a vibrator, a light emitting diode display, a thin-film transistor (TFT) display, a liquid crystal display, an active-matrix organic light-emitting diode (AMOLED) display, and the like.

The communication interface enables the computing system to communicate with other entities over various types of wired, wireless or combinations of wired and wireless networks, such as for example, the Internet. In at least one example embodiment, the communication interface includes a transceiver circuitry configured to enable transmission and reception of data signals over the various types of communication networks. In some embodiments, the communication interface may include appropriate data compression and encoding mechanisms for securely transmitting and receiving data over the communication networks. The communication interface facilitates communication between the computing system and I/O peripherals.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, server computers, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The benefits and advantages described above may relate to one embodiment or may relate to several embodiments. The embodiments are not limited to those that solve any or all of the stated problems or those that have any or all of the stated benefits and advantages. The operations of the methods described herein may be carried out in any suitable order, or simultaneously where appropriate. Additionally, individual blocks may be added or deleted from any of the methods without departing from the spirit and scope of the subject matter described herein. Aspects of any of the examples described above may be combined with aspects of any of the other examples described to form further examples without losing the effect sought.

The above description is given by way of example only and various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

What is claimed is:

1. A soft gripper comprising at least one actuator, the at least one actuator comprising:
a top layer and a bottom layer;
wherein the top layer comprises at least one fluid chamber a plurality of compartments separated from each other and interconnected to induce flexion upon introduction of a fluid into the at least one fluid chamber; and
wherein the bottom layer comprises an auxetic structure adaptable to conform to an object being grasped.

2. The soft gripper of claim 1, wherein the auxetic structure is at least one of a 2-dimensional structure and a 3-dimensional structure.

3. The soft gripper of claim 2, wherein the at least one soft gripper is pneumatically actuated, such that application of the fluid to the top layer causes the top layer to bend around the bottom layer, and thereby conform to the shape of the object being grasped.

4. The soft gripper of claim 3, wherein the fluid pressure is regulated to create a desired deformation profile suitable for gripping the object.

5. The soft gripper of claim 4, further comprising at least one sensor and at least one valve for regulation of the fluid pressure and control a grasping force on the object.

6. The soft gripper of claim 1, wherein the fluid is at least one of air, a gas and a gas mixture.

7. A method of manufacture for an actuator comprising:
using an extrusion process to create an auxetic structure;
molding a fluid chamber comprising a fluid channel with a plurality of compartments separated from each other and interconnected to each other by the air channel;
integrating the fluid chamber with the auxetic structure.

8. The method of claim 7, wherein the auxetic structure comprises a re-entrant honeycomb auxetic geometry featuring a re-entrant angle (Θ), a height (h), a thickness (l) and a 2l cos(Θ) value chosen such that the auxetic structure readily collapses on itself when subjected to a pressure loading without treating.

9. The method of claim 8, wherein the auxetic structure is 2-dimensional.

10. The method of claim 8, wherein the auxetic structure is 3-dimensional.

11. A method of manufacture for an actuator comprising the step of:
3D printing the actuator, wherein the actuator comprises:
a top layer and a bottom layer;
wherein the top layer comprises at least one fluid chamber comprising a plurality of compartments and interconnected to induce flexion upon introduction of a fluid into the at least one fluid chamber; and
wherein the bottom layer comprises an auxetic structure adaptable to conform to an object being grasped.

12. The method of claim 11, wherein the auxetic structure comprises a re-entrant honeycomb auxetic geometry featuring a re-entrant angle (Θ), a height (h), a thickness (l) and a 2l cos(Θ) value chosen such that the auxetic structure readily collapses on itself when subjected to a pressure loading without treating.

13. The method of claim 11, wherein the 3D printing is based on plates and shells.

14. The method of claim 13, wherein the actuator is integrally formed.

15. The method of claim 11, wherein the plurality of compartments are configured to receive the fluid individually and create a deformation profile suited for gripping the object.

16. An actuator comprising:
a top layer and a bottom layer; wherein the top layer comprises at least one fluid chamber having an air column with a series of sections separated from each other and interconnected to induce flexion upon introduction of a fluid into the at least one fluid chamber; and wherein the bottom layer comprises an auxetic structure adaptable to conform to an object being grasped.

17. The actuator of claim 16, wherein the fluid is introduced into the at least one fluid chamber by a pneumatic system.

18. The actuator of claim 17, wherein the pneumatic system is controllable to regulate the fluid pressure in the the at least one fluid chamber.

19. The actuator of claim 18, wherein the fluid is at least one of a gas and a gas mixture.

20. The actuator of claim 19, further comprising at least one sensor and at least one valve for regulation of the fluid pressure and control a grasping force on the object.
